(19) United States
(12) Patent Application Publication
(10) Pub. No.: US 2026/0253921 A1
(43) Pub. Date: Aug. 27, 2026

(54) HEAT ENERGY RECOVERY SYSTEM FOR FUEL CELL EXHAUST GAS

(71) Applicants: SAMJUNGTECH CO., LTD, Seoul (KR); SK ECOPLANT CO., LTD, Seoul (KR)

(72) Inventors: Su Yong LEE, Changwon-si (KR); Sung Min WOO, Busan (KR); Seokyoung YUN, Gwangmyeong-si (KR); Keun Wook KIM, Seoul (KR); Ho June LEE, Seoul (KR); Ju Seung LEE, Bucheon-si (KR); In Mook LIM, Seoul (KR)

(21) Appl. No.: 19/063,725

(22) Filed: Feb. 26, 2025

(51) Int. Cl. H01M 8/04029; H01M 8/04007; H01M 8/0432; H01M 8/04746

(52) U.S. Cl. CPC H01M 8/04029; H01M 8/04052; H01M 8/04343; H01M 8/0435; H01M 8/04373; H01M 8/04776

(57) ABSTRACT

The heat energy recovery system includes a plurality of fuel cells (11, …, 17) generating electricity and discharging exhaust gas, a plurality of heat exchangers (21, …, 27) disposed on the fuel cells exchanging heat between the discharged exhaust gas and a supplied heat transfer medium, a plurality of gas distributors (31, …, 37) uniformly distributing the exhaust gas discharged from the fuel cells to the heat exchangers, a heat storage tank (110) receiving and storing heat from the heat-exchanged heat transfer medium from the heat exchangers, a circulation pump (120) circulating the heat transfer medium for heat exchange between the heat storage tank (110) and the plurality of heat exchangers (21, …, 27), a heat transfer medium supply unit (210) supplying the heat transfer medium from an external source, a heat energy demand unit (310) receiving and utilizing the heat transfer medium.

### STATEMENT REGARDING PRIOR DISCLOSURES BY INVENTOR OR A JOINT INVENTOR

Korean Publication No. 102643049 dated March 4, 2024 is a grace period inventor-originated disclosure which occurred within one year of the filing date of this application and qualifies as an exception under 35 U.S.C. § 102(b)(1).

### BACKGROUND OF THE INVENTION

### Field of the Invention

This invention relates to a system for recovering heat energy from exhaust gas generated by fuel cells. More particularly, this invention relates to a system for recovering heat from low-temperature exhaust gas generated by fuel cells at temperatures between 110℃ and 150℃.

### Description of the Related Art

The installation of small and medium-scale power generation fuel cell systems is increasing both domestically and internationally. Accordingly, technologies for utilizing waste heat generated within fuel cells are also developing. The methods for utilizing waste heat generated from fuel cells are closely related to the characteristics of different types of fuel cells.

Power generation fuel cells primarily utilize Phosphoric Acid Fuel Cells (PAFC) and Solid Oxide Fuel Cells (SOFC). Each fuel cell type has different operating environments, resulting in significant variations in the temperature and quantity of waste heat generated.

Phosphoric Acid Fuel Cells have relatively lower power generation efficiency, but the temperature of waste heat generated inside the fuel cell is comparatively high. By utilizing this waste heat, it is possible to produce and utilize medium-temperature water at approximately 90~100℃.

In contrast, Solid Oxide Fuel Cells have very high power generation efficiency. However, since these fuel cells prioritize power generation efficiency, the temperature of the waste heat generated is relatively lower compared to Phosphoric Acid Fuel Cells. Solid Oxide Fuel Cells typically discharge low-temperature exhaust gas at 100~150℃. This exhaust gas has a large specific volume and low specific heat, making it currently unutilized.

To utilize this exhaust gas, a large heat exchanger capable of securing sufficient heat transfer area is required. However, due to the high installation costs of large heat exchangers, this waste heat is currently being discharged without recycling due to economic feasibility issues.

Furthermore, the exhaust gas contains moisture levels ranging from 1%mol to 1.2%mol. Due to this characteristic, in environments where the external temperature drops below 0℃, such as during winter, the white smoke phenomenon inevitably occurs in exhaust gas discharged at 50~60℃ after heat recovery.

White smoke is a fog-like phenomenon that occurs when water vapor in the exhaust gas meets cold external air. This phenomenon occurs when water vapor condenses into fine particles, and while it is not hazardous in itself, it can become a serious issue when occurring at power generation fuel cell facilities as the general public may misinterpret it as a dangerous situation such as fire.

### BRIEF SUMMARY OF THE INVENTION

The heat energy recovery system includes a plurality of fuel cells (11, …, 17) generating electricity and discharging exhaust gas, a plurality of heat exchangers (21, …, 27) disposed on the fuel cells exchanging heat between the discharged exhaust gas and a supplied heat transfer medium, a plurality of gas distributors (31, …, 37) uniformly distributing the exhaust gas discharged from the fuel cells to the heat exchangers, a heat storage tank (110) receiving and storing heat from the heat-exchanged heat transfer medium from the heat exchangers, a circulation pump (120) circulating the heat transfer medium for heat exchange between the heat storage tank (110) and the plurality of heat exchangers (21, …, 27), a heat transfer medium supply unit (210) supplying the heat transfer medium from an external source, a heat energy demand unit (310) receiving and utilizing the heat transfer medium.

In one embodiment, the heat energy recovery system may further includes a first feed control valve (V2) controlling movement of the heat transfer medium between the plurality of heat exchangers (21, …, 27) and the heat energy demand unit (310) and a second feed control valve (V3) controlling movement of the heat transfer medium between the heat storage tank (110) and the heat energy demand unit (310). The heat energy demand unit (310) may selectively receive the heat transfer medium from the plurality of heat exchangers (21, …, 27) and the heat storage tank (110). When the amount of heat energy recovered from the plurality of heat exchangers (21, …, 27) equals the amount of heat energy required by the heat energy demand unit (310), only the first feed control valve may open, and When the amount of heat energy recovered from the plurality of heat exchangers (21, …, 27) is less than the amount of heat energy required by the heat energy demand unit (310), the second feed control valve additionally may open.

In one embodiment, the plurality of fuel cells (11, …, 17) may be Solid Oxide Fuel Cells (SOFC), and during operation, one of the plurality of fuel cells may be in standby state while the remaining fuel cells are in operation state generating electricity.

In one embodiment, the heat exchangers (21, …, 27) may be fin-tube type.

In one embodiment, the heat energy recovery system may further include a supply control valve (V1) controlling selective delivery of the heat transfer medium from the heat transfer medium supply unit (210) to the heat storage tank (110) and the plurality of heat exchangers (21, …, 27).

In one embodiment, the heat energy recovery system may further include a main heat exchange control valve (V4) controlling inflow of the heat transfer medium to the plurality of heat exchangers (21, …, 27) to simultaneously control all heat exchange within the heat exchangers (21, …, 27) and a plurality of heat exchanger temperature sensors (S2-1, ...S2-7) measuring the temperature of each of the plurality of heat exchangers (21, ..., 27) individually. When white smoke phenomenon is detected by the plurality of heat exchanger temperature sensors (S2-1, ...S2-7), the main heat exchange control valve (V4) may be controlled accordingly.

In one embodiment, 7. the heat energy recovery system may further include a heat storage tank temperature sensor (S1) measuring the temperature of the heat storage tank (110); and a hot water outlet temperature sensor (S4) measuring the temperature of the heat transfer medium discharged from the heat exchangers (21, ..., 27).

In one embodiment, the heat energy recovery system may further include a plurality of individual heat exchange control valves (V5-1, ...,V5-7) controlling inflow of the heat transfer medium to each respective heat exchanger (21, ..., 27) to individually control heat exchange within each heat exchanger; and a plurality of exhaust gas temperature sensors (S3-1, ..., S3-7) measuring the temperature of exhaust gas from the plurality of fuel cells (11, ..., 17), wherein when a standby state is detected for any of the plurality of fuel cells (11, ... , 17) by the plurality of exhaust gas temperature sensors (S3-1, ..., S3-7), the individual heat exchange control valve corresponding to that fuel cell closes.

In one embodiment, 9. the gas distributor may include a V-type distributor (31a) and a support frame (13b) for mounting the distributor, and the V-type distributor (31a) may include at least four sides with triangular cross-sections, with the vertices of the triangles pointing toward the center.

In one embodiment, 10. the gas distributor may include first and second U-type distributors (31c, 31d), and wherein the first U-type distributor (31c) has a larger cross-sectional area than the second U-type distributor (31d) and is positioned below the second U-type distributor (31d).

### BRIEF DESCRIPTION OF THE DRAWINGS

FIG. 1 is a configuration diagram illustrating the heat energy recovery system of the present invention.

FIG. 2 is a diagram illustrating the V-type gas distributor configuration of the present invention.

FIG. 3 is a diagram illustrating the arrangement of distribution plates in the gas distributor.

FIG. 4 is a diagram illustrating the flow of exhaust gas through the distribution plates.

FIG. 5 is a diagram illustrating an alternative configuration of the gas distributor with two-row arrangement.

FIG. 6 is a diagram illustrating the individual heat exchange control valve configuration.

FIG. 7 is a diagram illustrating the U-type gas distributor configuration.

### DETAILED DESCPTION OF THE INVENTION

Hereinafter, preferred embodiments will be described with reference to the accompanying drawings. In this process, the thickness of lines or the size of components shown in the drawings may be exaggerated for clarity and convenience of explanation. Also, the terms described below are defined in consideration of the functions in the present invention, and may vary according to the user's or operator's intention or custom. Therefore, the definitions of these terms should be made based on the entire content of this specification.

In this specification, a module may refer to a functional and structural combination of hardware for performing the technical idea of the present invention and software for driving the hardware. For example, the module may refer to a logical unit of predetermined code and hardware resources for executing the predetermined code, and it is not necessarily meant to refer to physically connected code or a single type of hardware, which can be easily inferred by an average expert in the technical field of the present invention.

Also, when it is mentioned that a component is "connected" or "connected" to another component, it should be understood that it may be directly connected or connected to the other component, but other components may exist in between. On the other hand, when it is mentioned that a component is "directly connected" or "directly connected" to another component, it should be understood that no other components exist in between.

The singular expression includes the plural expression unless the context clearly indicates otherwise. Also, throughout this specification, when a part is said to "include" a component, it means that it may include other components in addition to the component, unless specifically stated otherwise. It is apparent to those skilled in the art that the present invention can be embodied in other specific forms without departing from the essential characteristics of the present invention.

In addition, the following embodiments are presented as examples and are not intended to limit the scope of the present invention, and various embodiments may be implemented through the technical idea of the present invention. Hereinafter, embodiments of the present invention will be described in detail with reference to the drawings. The same reference numerals in the drawings refer to the same elements.

### Configuration of the Heat Energy Recovery System

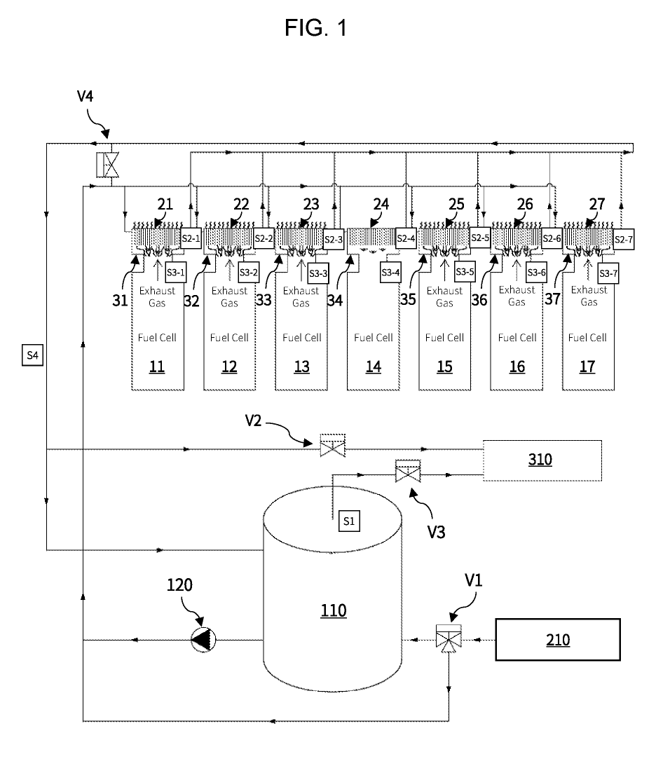

FIG. 1 is a configuration diagram illustrating an embodiment of the heat energy recovery system according to the present invention.

Referring to FIG. 1, the heat energy recovery system of the present embodiment includes a plurality of fuel cells (11, ...17), a plurality of heat exchangers (21, ...27) disposed on each fuel cell to exchange heat between the exhaust gas discharged from the fuel cells and a supplied heat transfer medium, a plurality of gas distributors (31, ...37) that uniformly distribute the exhaust gas discharged from the fuel cells to the heat exchangers, a heat storage tank (110) that receives and stores heat from the heat-exchanged heat transfer medium from the heat exchangers, a circulation pump (120) that circulates the heat transfer medium for heat exchange between the heat storage tank (110) and the plurality of heat exchangers (21, ...27), a heat transfer medium supply unit (210) that supplies the heat transfer medium from an external source, and a heat energy demand unit (310) that receives and utilizes the heat transfer medium.

In the present embodiment, the heat energy demand unit (310) selectively receives the heat transfer medium from the plurality of heat exchangers (21, ...27) and the heat storage tank (110), and this selective transfer is implemented by a supply control valve (V1) that controls the selective transfer of heat transfer medium from the heat transfer medium supply unit (210) to the heat storage tank (110) and the plurality of heat exchangers (21, ...27).

Additionally, the heat energy recovery system includes a first feed control valve (V2) that controls the movement of heat transfer medium between the plurality of heat exchangers (21, ...27) and the heat energy demand unit (310), a second feed control valve (V3) that controls the movement of heat transfer medium between the heat storage tank (110) and the heat energy demand unit (310), and a main heat exchange control valve (V4) that controls the inflow of heat transfer medium to the plurality of heat exchangers (21, ...27) to simultaneously control heat exchange in all heat exchangers (21, ...27).

The fuel cells (11, ...17) are Solid Oxide Fuel Cells (SOFC), and the heat exchangers (21, ...27) are characterized as being of the fin-tube type.

### 24-Hour Continuous Operation Configuration

Referring again to FIG. 1, the power generation system of the present embodiment typically includes seven fuel cells (11, ...17). During normal operation, one fuel cell maintains a standby state while the remaining six fuel cells produce power. In the present embodiment, the fourth fuel cell (14) maintains a standby state, while the first, second, third, fifth, sixth, and seventh fuel cells (11, 12, 13, 15, 16, 17) are producing power. In the present system, the fuel cell in standby state changes sequentially, ensuring that out of the total seven fuel cells, one is always in standby state while the others are operating to generate power. This operational method is designed to enable the system to operate continuously 24 hours a day, 365 days a year.

In the present embodiment, the six currently operating fuel cells are all Solid Oxide Fuel Cells, and high-temperature exhaust gas of approximately 100~150℃ is generated at the exhaust gas outlet in the upper part of each fuel cell module. The high-temperature exhaust gas generated from these fuel cells (11, ...17) is recovered by heat exchangers (21, ...27) installed at the top of each fuel cell, and the heat exchangers used are typically fin-tube type, which provides excellent heat exchange efficiency.

### Heat Energy Storage Operation

When there is no heat energy demand from the heat energy demand unit (310), the system operates by storing all heat energy generated by the fuel cells in the heat storage tank (110). For example, during nighttime hours when hot water usage is minimal, the heat energy generated during this period is efficiently stored in the heat storage tank (110).

During this heat energy storage operation, the circulation pump (120) continues to operate even when there is no heat usage from the heat energy demand unit (310). During this time, the heat transfer medium continuously exchanges heat energy with the exhaust gas generated from the fuel cells while circulating to store heat in the heat storage tank (110).

### Operation During Heat Energy Demand

The system operates in two different ways when heat energy demand occurs at the heat energy demand unit (310).

The first mode is when the amount of heat energy generated in real-time by the fuel cells (11, ...17) is similar to the amount of heat energy requested by the heat energy demand unit (310), in which case no additional heat supply from the heat storage tank (110) is needed.

In this case, the system controls the heat transfer medium flow as follows. First, the supply control valve (V1) is controlled to close towards the heat storage tank (110) direction and open towards the heat exchangers (21, ...27) direction. Accordingly, the heat transfer medium is not transferred to the heat storage tank (110) but is directly supplied to the fuel cells (11, ...17) in full amount, where it is heated and then naturally circulated to the heat energy demand unit (310) through the first feed control valve (V2).

During this operation, the hot water outlet temperature sensor (S4) continuously measures the temperature to determine in real-time whether additional heat supply from the heat storage tank (110) is needed while the system operates.

When the heat load demand from the heat energy demand unit (310) becomes greater than the amount of heat energy generated by the fuel cells (11, ...17), the system operates as follows. First, the second feed control valve (V3) controlling the heat transfer medium in the heat storage tank (110) opens, and simultaneously, the valve between the supply control valve (V1) and the heat storage tank (110) opens. This allows the heat transfer medium stored in the heat storage tank (110) to be supplied simultaneously through the first feed control valve (V2) and the second feed control valve (V3) to supplement the insufficient heat.

For efficient system operation, the heat storage tank temperature sensor (S1) continuously measures the temperature inside the heat storage tank (110) to optimize the operation of the circulation pump (120). This is crucial because the primary function of fuel cells is power generation, making it very important to minimize power consumption in the heat recovery system. Therefore, the system operates the circulation pump (120) only when storing heat energy from exhaust gas in the heat storage tank (110), and implements variable control based on the temperature measured by the heat storage tank temperature sensor (S1) at the top of the heat storage tank (110) to minimize power consumption.

### White Smoke Prevention Operation

Referring again to FIG. 1, the white smoke prevention operation will be explained. In the present embodiment, accurate detection of conditions that cause white smoke is crucial for effective white smoke prevention operation. For this purpose, each of the multiple heat exchangers (21, ..., 27) is equipped with multiple heat exchanger temperature sensors (S2-1, ...S2-7) that can measure their temperatures individually.

One of the characteristic phenomena of the present embodiment occurs when the external air temperature drops below freezing. In such low-temperature environments, the temperature of the heat transfer medium supplied from the heat transfer medium supply unit (210) also decreases. Generally, water is used as the heat transfer medium, and in this case, the supply temperature of the heat transfer medium shows a low temperature range of 5~15℃.

The temperature of low-temperature exhaust gas discharged from Solid Oxide Fuel Cells varies according to seasonal characteristics, which is due to the temperature difference caused by partial inflow of external air. In summer, based on an external air temperature of 30℃, the average temperature of exhaust gas maintains around 150℃. In winter, based on an external air temperature of 0℃, it shows about 120℃, and the temperature of exhaust gas discharged from the upper part of the fuel cells (11, ...17) is also discharged at a temperature 20~30℃ lower than in summer due to the influence of external air.

Due to these seasonal characteristics, operating the heat recovery system in the same control method during winter when external air temperatures are low as in summer inevitably leads to white smoke generation. The white smoke phenomenon is similar to ordinary smoke and can generate such a large amount of water vapor that it could be mistaken for fire, causing anxiety among nearby residents and leading to side effects such as false fire reports.

Particularly, in periods like winter when both the supply temperature of the heat transfer medium is low and the exhaust gas temperature is relatively low, the probability of white smoke occurrence becomes very high even with the same heat exchanger system. For this purpose, the system provides perfect white smoke prevention throughout all four seasons, especially in winter.

The heat energy recovery system according to the present embodiment can completely prevent white smoke generation during heat accumulation or real-time heat recovery even during winter periods when external air temperature falls below freezing through this control method.

This is because when the flow rate demand increases while the temperature of the heat transfer medium supplied through the heat energy demand unit (310) is low during winter, the temperature of exhaust gas discharged from the heat exchangers (21, ...27) can drop to 50~60℃ level either locally or overall. This can necessarily cause white smoke generation. In the present embodiment, to prevent such white smoke generation, the heat exchanger outlet temperature sensors (S2-1, ...S2-7) installed at the outlet of the heat exchangers (21, ...27) continuously monitor the conditions for white smoke generation.

When the temperature detected by the outlet temperature sensors reaches a range where white smoke generation is possible, the opening degree of the main heat exchange control valve (V4) is adjusted to control the exhaust gas temperature at the heat exchanger outlet. Partially closing the main heat exchange control valve (V4) reduces the circulation of heat transfer medium, which in turn reduces the heat exchange in the heat exchangers (21, ...27), causing the exhaust gas temperature to rise and consequently preventing the white smoke phenomenon.

During this control process, there may be cases where the heat energy demand from the heat energy demand unit (310) remains unchanged even when the heat exchange in the heat exchangers (21, ...27) decreases. In such cases, the system can meet the load demands of the heat energy demand unit (310) by simultaneously supplying heat energy stored in the heat storage tank (110). The present system prioritizes white smoke prevention control through the main heat exchange control valve (V4), considering that the social risk from white smoke generation is greater than the economic value of heat recovery.

### Need for Gas Distributors

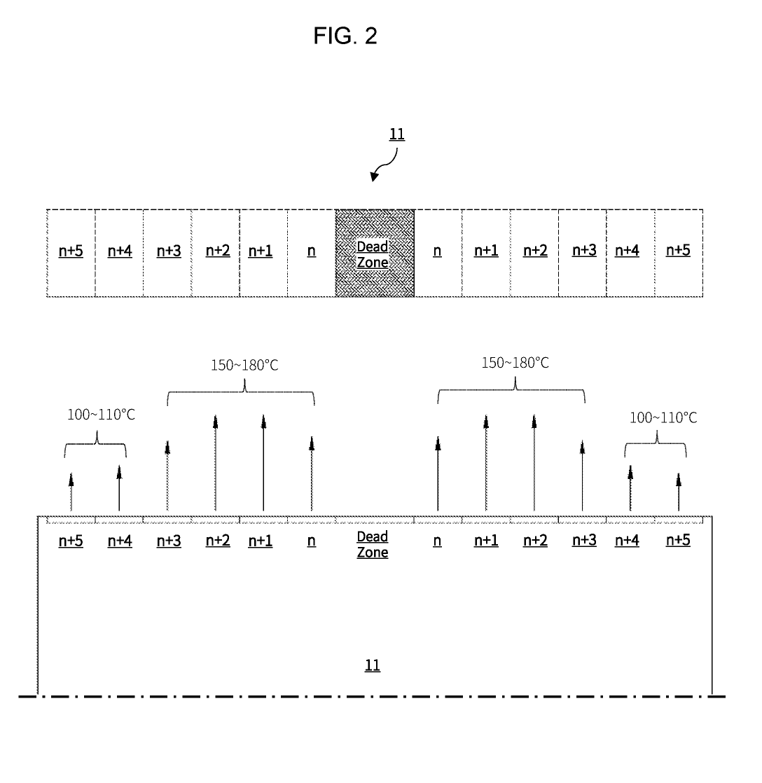

FIG. 2 is a configuration diagram illustrating the fuel cell structure of the heat energy recovery system according to the embodiment of FIG. 1. In particular, it shows a plan view at the top and a side view at the bottom of the same section centered on the upper part of the first fuel cell (11).

Referring to FIG. 2, the exhaust ports at the top of the fuel cell are sequentially arranged from n to n+5 from the center to both sides, and there is a dead zone where exhaust gas is not discharged in the center. As can be seen in the side view, there are variations in temperature and flow rate depending on the location of the exhaust ports, with higher flow rates and temperatures particularly closer to the center.

This non-uniform exhaust gas discharge is a major cause of reduced heat exchange efficiency in heat exchangers (21, ...27). Especially in the case of Solid Oxide Fuel Cells (SOFC), these temperature and flow rate variations cause thermal stress within the stack, directly affecting the system's lifespan and performance. Therefore, a device for uniformly distributing exhaust gas is essential for efficient operation of the entire system.

### Gas Distributor

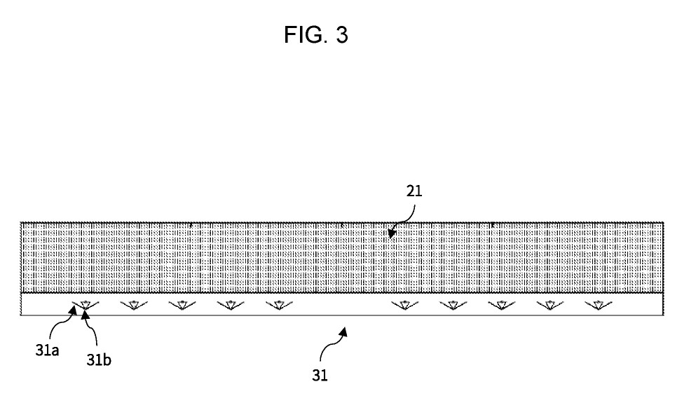

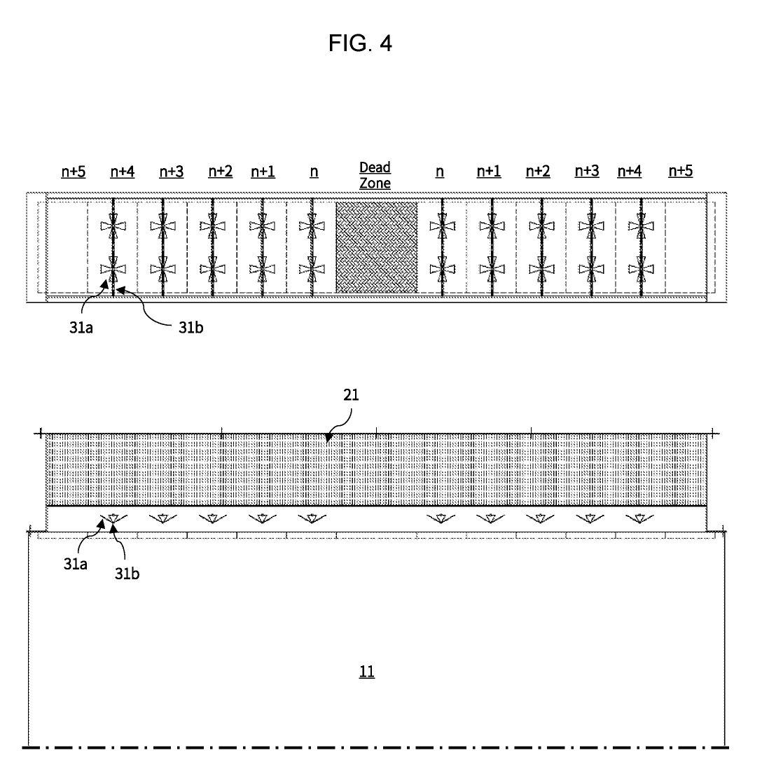

FIG. 3 is a configuration diagram illustrating the gas distributor according to the embodiment of FIG. 1. FIG. 4 is a configuration diagram showing a portion of the fuel cell with the gas distributor applied according to the embodiment of FIG. 1.

The present embodiment focuses on explaining the heat exchanger (21) and gas distributor (31) located above the first fuel cell (11), and since this configuration has the same structure as those located above the second through seventh fuel cells (11), we will explain based on the first fuel cell (11).

Referring to FIGS. 3 and 4, the gas distributor (31) of this invention is located at the exhaust gas outlet side of the fuel cell (11) below the heat exchanger (21), and this gas distributor (31) includes a V-type distributor (31a) and a support frame (13b) for mounting the V-type distributor (31a). The V-type distributor (31a) functions to disperse the exhaust gas rising from below and ensure uniform entry of gas into the heat exchanger (21).

The exhaust gas passing through the gas distributor (31) is evenly distributed across all parts of the heat exchanger (21), effectively utilizing the entire heat transfer area to transfer heat before being discharged. An important point in this process is that the resistance during exhaust gas discharge should be low, and simultaneously the heat recovery unit should be compact, requiring the design of a special compact distributor that considers both low pressure drop and air flow.

Referring again to FIG. 4, the V-type distributor (31a) of this invention has a triangular cross-section and is implemented in a shape including at least 4 sides arranged with the vertices of the triangles pointing toward the center. This structure can be utilized as an optimal structure that can minimize exhaust gas resistance while simultaneously distributing exhaust gas evenly.

### Gas Distributor Embodiment

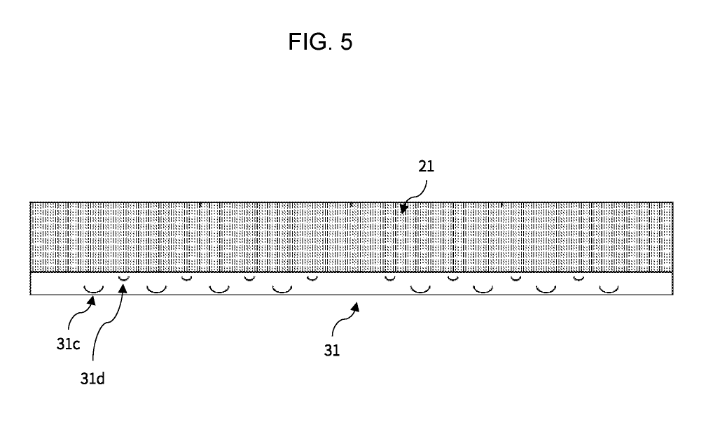

FIG. 5 is a configuration diagram illustrating a gas distributor according to another embodiment of this invention.

Referring to FIG. 5, the gas distributor (31) according to the present embodiment consists of a structure including first and second U-type distributors (31c, 31d). This structure is different from the previously explained embodiment and is characterized by a U-shaped structure with a gentle curvature in the downward direction.

Particularly, in the gas distributor (31) including the U-shaped structure of the present embodiment, the first and second U-type distributors (31c, 31d) are arranged vertically, with the first U-type distributor (31c) having a larger cross-sectional area and being formed at the bottom compared to the second U-type distributor (31d).

In this structure, the distributors are arranged in two rows at the top and bottom, and the distributor located at the top has a smaller cross-sectional area than the bottom, forming a structure that can more effectively reduce gas resistance.

### Individual Heat Exchange Control Valve Embodiment for Optimal Control

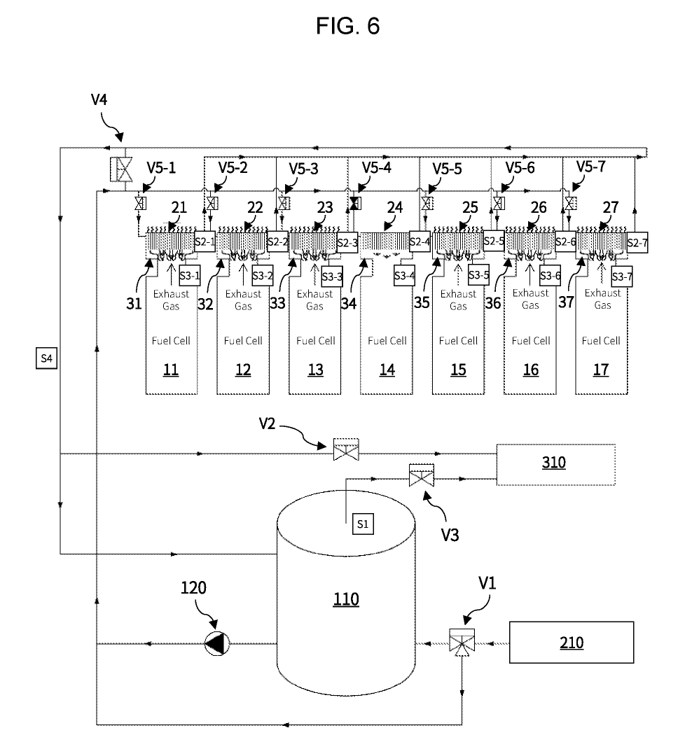

FIG. 6 is a configuration diagram illustrating a heat energy recovery system according to yet another embodiment of the present invention.

Referring to FIG. 6, the present embodiment is identical to the embodiment explained in FIG. 1 except that it additionally includes multiple individual heat exchange control valves (V5-1, ...V5-7) that control the inflow of heat transfer medium to each of the multiple heat exchangers (21, ...27) to individually control heat exchange within each heat exchanger (21, ...27).

The embodiment of FIG. 6 shows an operation method considering the characteristic that not all fuel cells operate simultaneously and one fuel cell operates in standby mode. As mentioned earlier, among the 7 fuel cells, 1 is in standby state while the remaining 6 are in operation, and the fuel cell that goes into standby state alternates sequentially according to a certain period.

In such a system, there is concern about heat energy loss due to the circulation of heat transfer medium to the heat exchanger installed on the fuel cell that goes into standby state. Therefore, it is characteristic that the individual heat exchange control valves (V5-1, ...V5-7) control so that heat transfer medium does not circulate and heat exchange does not occur for fuel cells in standby state.

In this figure, since the fourth fuel cell (14) is in standby state, accordingly, the fourth individual heat exchange control valve (V5-4) closes.

The control system of this invention can implement control in conjunction with fuel cells for efficient heat recovery. Additionally, multiple exhaust gas temperature sensors (S3-1, ...S3-7) that measure the exhaust gas temperature of multiple fuel cells (11, ...17) can be additionally installed, through which the current exhaust gas temperature is measured at each exhaust gas temperature sensor (S3-1, ...S3-7). If the exhaust gas temperature deviates from the normal range, it is determined that the corresponding fuel cell is not operating, and the corresponding individual heat exchange control valve (V5-1, ...V5-7) can be controlled to close.

### Embodiment for Minimum Configuration

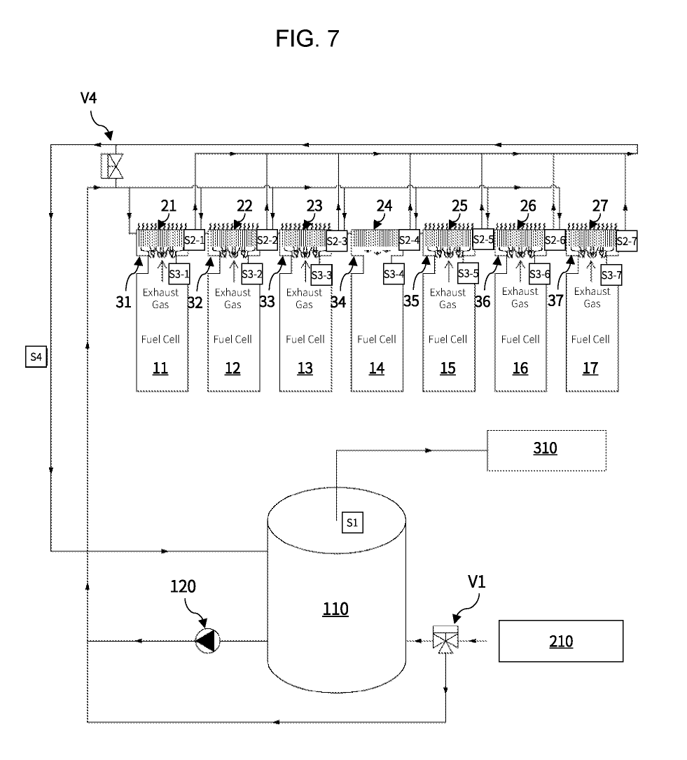

FIG. 7 is a configuration diagram illustrating a heat energy recovery system according to yet another embodiment of the present invention.

In the present embodiment, the first feed control valve (V2) and second feed control valve (V3) are not included in the system, and the heat transfer medium supplied to the heat energy demand unit (310) is provided only from the heat storage tank (110).

This minimum configuration embodiment enables the implementation of a heat energy recovery system with a simpler system by omitting unnecessary components and using only essential configurations.

As described above, although the embodiments have been explained with limited diagrams, those skilled in the art can apply various technical modifications and variations based on the above. For example, the described technologies can be performed in a different order than described, and/or the components of the described systems, structures, devices, circuits, etc., can be combined or combined in a different form than described, or replaced or substituted by other components or equivalents, achieving appropriate results. Therefore, other implementations, other embodiments, and equivalents to the claims below are also within the scope of the claims.

What is claimed is:

1. A heat energy recovery system comprising:
a plurality of fuel cells (11, …, 17) generating electricity and discharging exhaust gas;
a plurality of heat exchangers (21, …, 27) disposed on the fuel cells exchanging heat between the discharged exhaust gas and a supplied heat transfer medium;
a plurality of gas distributors (31, …, 37) uniformly distributing the exhaust gas discharged from the fuel cells to the heat exchangers;
a heat storage tank (110) receiving and storing heat from the heat-exchanged heat transfer medium from the heat exchangers;
a circulation pump (120) circulating the heat transfer medium for heat exchange between the heat storage tank (110) and the plurality of heat exchangers (21, …, 27);
a heat transfer medium supply unit (210) supplying the heat transfer medium from an external source;
a heat energy demand unit (310) receiving and utilizing the heat transfer medium;

2. The heat energy recovery system of claim 1, further comprising:
a first feed control valve (V2) controlling movement of the heat transfer medium between the plurality of heat exchangers (21, …, 27) and the heat energy demand unit (310); and
a second feed control valve (V3) controlling movement of the heat transfer medium between the heat storage tank (110) and the heat energy demand unit (310),
wherein the heat energy demand unit (310) selectively receives the heat transfer medium from the plurality of heat exchangers (21, …, 27) and the heat storage tank (110),
wherein when the amount of heat energy recovered from the plurality of heat exchangers (21, …, 27) equals the amount of heat energy required by the heat energy demand unit (310), only the first feed control valve opens, and
wherein when the amount of heat energy recovered from the plurality of heat exchangers (21, …, 27) is less than the amount of heat energy required by the heat energy demand unit (310), the second feed control valve additionally opens.

3. The heat energy recovery system of claim 2,
wherein the plurality of fuel cells (11, …, 17) are Solid Oxide Fuel Cells (SOFC), and
wherein during operation, one of the plurality of fuel cells is in standby state while the remaining fuel cells are in operation state generating electricity.

4. The heat energy recovery system of claim 2,
wherein the heat exchangers (21, …, 27) are fin-tube type.

5. The heat energy recovery system of claim 2, further comprising:
a supply control valve (V1) controlling selective delivery of the heat transfer medium from the heat transfer medium supply unit (210) to the heat storage tank (110) and the plurality of heat exchangers (21, …, 27).

6. The heat energy recovery system of claim 1, further comprising:
a main heat exchange control valve (V4) controlling inflow of the heat transfer medium to the plurality of heat exchangers (21, …, 27) to simultaneously control all heat exchange within the heat exchangers (21, …, 27); and
a plurality of heat exchanger temperature sensors (S2-1, ...S2-7) measuring the temperature of each of the plurality of heat exchangers (21, ..., 27) individually;
wherein when white smoke phenomenon is detected by the plurality of heat exchanger temperature sensors (S2-1, ...S2-7), the main heat exchange control valve (V4) is controlled accordingly.

7. The heat energy recovery system of claim 2, further comprising:
a heat storage tank temperature sensor (S1) measuring the temperature of the heat storage tank (110); and
a hot water outlet temperature sensor (S4) measuring the temperature of the heat transfer medium discharged from the heat exchangers (21, ..., 27).

8. The heat energy recovery system of claim 1, further comprising:
a plurality of individual heat exchange control valves (V5-1, ...,V5-7) controlling inflow of the heat transfer medium to each respective heat exchanger (21, ..., 27) to individually control heat exchange within each heat exchanger; and
a plurality of exhaust gas temperature sensors (S3-1, ..., S3-7) measuring the temperature of exhaust gas from the plurality of fuel cells (11, ..., 17),
wherein when a standby state is detected for any of the plurality of fuel cells (11, ... , 17) by the plurality of exhaust gas temperature sensors (S3-1, ..., S3-7), the individual heat exchange control valve corresponding to that fuel cell closes.

9. The heat energy recovery system of claim 1,
wherein the gas distributor includes a V-type distributor (31a) and a support frame (13b) for mounting the distributor, and
wherein the V-type distributor (31a) includes at least four sides with triangular cross-sections, with the vertices of the triangles pointing toward the center.

10. The heat energy recovery system of claim 1,
wherein the gas distributor includes first and second U-type distributors (31c, 31d), and
wherein the first U-type distributor (31c) has a larger cross-sectional area than the second U-type distributor (31d) and is positioned below the second U-type distributor (31d).
